(19) United States
(12) Patent Application Publication
(10) Pub. No.: US 2018/0246331 A1
(43) Pub. Date: Aug. 30, 2018

(54) HELMET-MOUNTED DISPLAY, VISUAL FIELD CALIBRATION METHOD THEREOF, AND MIXED REALITY DISPLAY SYSTEM

(71) Applicant: Acer Incorporated, New Taipei City (TW)

(72) Inventors: Chen-Ju CHENG, New Taipei City (TW); Wei-Kuo SHIH, New Taipei City (TW); Sergio CANTERO CLARES, New Taipei City (TW)

(21) Appl. No.: 15/861,046

(22) Filed: Jan. 3, 2018

(30) Foreign Application Priority Data
Feb. 24, 2017 (TW) 106106375

(51) Int. Cl. G02B 27/01; G06T 19/00; G06F 3/01; H04N 13/00

(52) U.S. Cl. CPC G02B 27/0172; H04N 13/0007; G06F 3/013; G06T 19/006

(57) ABSTRACT

The invention provides a helmet-mounted display, including: a camera capturing an environment image outside the helmet-mounted display; an infrared sensor sensing the pupil position of a human eye; an image processor calculating the visual field of the human eye according to the pupil position and cropping a visual field image corresponding to the visual field from the environment image; and a display panel displaying the visual field image.

### CROSS REFERENCE TO RELATED APPLICATIONS

This Application claims priority of Taiwan Patent Application No. 106106375, filed on Feb. 24, 2017, the entirety of which is incorporated by reference herein.

### BACKGROUND OF THE INVENTION

### Field of the Invention

The present invention relates to a helmet-mounted display, a visual field calibration method thereof, and a mixed reality display system, and in particular to a helmet-mounted display, a visual field calibration method thereof, and a mixed reality display system which can provide a visual field image suitable for users by software calibration.

### Description of the Related Art

Virtual reality is a popular technique that has been gradually maturing in recent years. A variety of products consisting of helmet-mounted displays that provide a virtual reality function have been introduced. In many kinds of helmet-mounted displays, there is a helmet-mounted display that adopts a mixed realty technology which combines virtual reality and augmented reality therein. This kind of helmet-mounted display is provided with a camera in the front of the helmet to capture a real environment image. A computer connected to the helmet-mounted display adds virtual objects, environmental effects, or information according to the real environment image, and transmits them back to the helmet-mounted display. Therefore, the user of the helmet-mounted display can see an environment that is formed by mixing the environment image with a virtual image.

However, people have different pupil distances and thus have different visual fields. When a helmet-mounted display is put on, only one kind of visual field is displayed because the location of the camera is fixed. If there is no calibration, the helmet-mounted display cannot display different visual fields for people having a different pupil distance. That causes the user to view an image that is blurry, to experience eyestrain, and to easily become dizzy, and so on.

Furthermore, the capturing field of the camera is larger than the visual field of one eye of the average person. In order to reduce the transmission bandwidth of the real image, only the image corresponding to the visual field of the user should be captured for transmission.

To address the above problem, the present invention provides a helmet-mounted display, a visual field calibration method thereof, and a mixed reality display system, capable of providing images suitable for the visual field of a user according to the user's pupil distance.

### BRIEF SUMMARY OF THE INVENTION

A detailed description is given in the following embodiments with reference to the accompanying drawings.

According to an embodiment, the present invention provides a helmet-mounted display, including: a camera capturing an environment image outside the helmet-mounted display; an infrared sensor sensing the pupil position of a human eye; an image processor calculating the visual field of the human eye according to the pupil position and cropping a visual field image corresponding to the visual field from the environment image; and a display panel displaying the visual field image.

In the helmet-mounted display, the camera includes an image sensor array formed from a plurality of pixels. The image processor extracts only image sensing signals of the pixels in an area corresponding to the visual field in the image sensor array.

In the helmet-mounted display, the image processor sets coordinates of pixels of the image sensor array that need to output the image sensing signal according to the visual field.

In the helmet-mounted display, the pupil position is the distance between the pupil and the nasal bridge centerline.

According to another embodiment, the present invention provides a mixed reality display system, including: a camera capturing an environment image; an infrared sensor sensing the pupil position of a human eye; an image processor calculating the visual field of the human eye according to the pupil position and cropping a visual field image corresponding to the visual field from the environment image; a computer receiving the visual field image and superimposing a virtual image to form a mixed image; and a display panel displaying the mixed field image.

In the mixed reality display system, the camera, the infrared sensor, the image processor, and the display panel form a helmet-mounted display.

In the mixed reality display system, the camera comprises an image sensor array formed from a plurality of pixels. The image processor extracts only image sensing signals of the pixels in an area corresponding to the visual field in the image sensor array.

In the mixed reality display system, the image processor sets coordinates of pixels of the image sensor array that need to output the image sensing signal according to the visual field.

According to another embodiment, the present invention provides a visual field calibration method of a helmet-mounted display, including: capturing an environment image that shows the exterior of the helmet-mounted display; sensing a pupil position of a user of the helmet-mounted display; calculating the user's visual field according to the pupil position; cropping a visual field image corresponding to the user's visual field from the environment image; and displaying the visual field image.

The visual field calibration method further includes superimposing a virtual image on the visual field image.

According to the helmet-mounted display, the visual field calibration method thereof, and the mixed reality display system, with software calibration, images suitable for the visual field of the user can be displayed according to the user's pupil distance. Furthermore, visual field images can be adjusted instantly while the user watches near objects or far objects.

### BRIEF DESCRIPTION OF THE DRAWINGS

The present invention can be more fully understood by reading the subsequent detailed description and examples with references made to the accompanying drawings, wherein:

FIG. 1 is a stereoscopic view showing a helmet-mounted display in accordance with an embodiment of the present invention;

FIG. 2 is a schematic top view showing the helmet-mounted display shown in FIG. 1;

FIG. 3 is an architecture diagram showing a mixed reality display system in according to an embodiment of the present invention;

FIGS. 4A-4C are diagrams for explaining the positions of an environment image and a visual field image with respect to an image sensor array when the pupil distance of human eyes PD is 63 mm;

FIGS. 5A-5C are diagrams for explaining the positions of an environment image and a visual field image with respect to an image sensor array when the pupil distance of human eyes PD is 66 mm; and

FIG. 6 is a flowchart showing a visual field calibration method of a helmet-mounted display in according to an embodiment of the present invention.

### DETAILED DESCRIPTION OF THE INVENTION

The following description is of the best-contemplated mode of carrying out the present invention. This description is made for the purpose of illustrating the general principles of the present invention and should not be taken in a limiting sense. The scope of the present invention is best determined by reference to the appended claims.

In addition, the present invention may repeat reference numerals and/or letters in the various examples. This repetition is for the purpose of simplicity and clarity and does not in itself dictate a relationship between the various embodiments and/or configurations discussed. Furthermore, the shape, size, and thickness in the drawings may not be drawn to scale or simplified for clarity of discussion; rather, these drawings are merely intended for illustration.

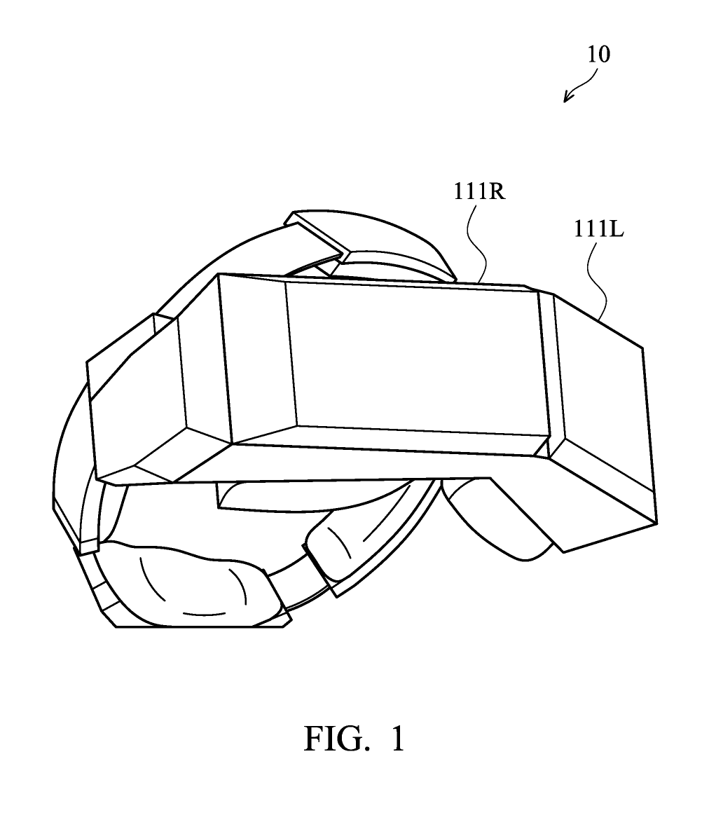

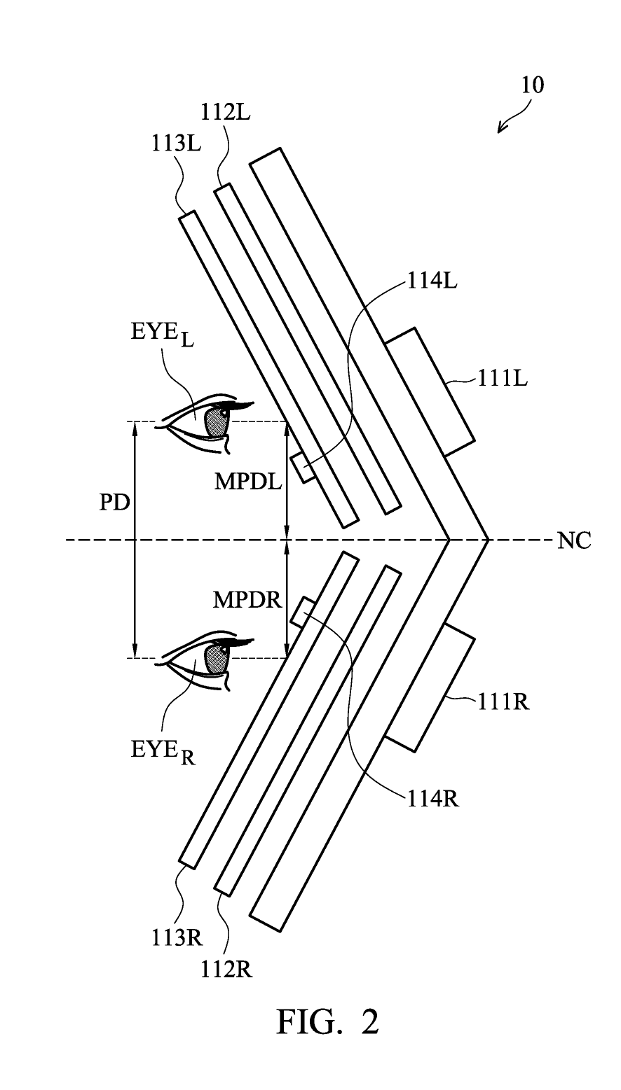

FIG. 1 is a stereoscopic view showing a helmet-mounted display in accordance with an embodiment of the present invention. FIG. 2 is a schematic top view showing the helmet-mounted display shown in FIG. 1. As shown in FIG. 1, a helmet-mounted display 10 of the present invention has cameras 111L and 111R, which are arranged on a front-facing surface of the helmet and used to capture a left-eye environment image and a right-eye environment image outside the helmet-mounted display 10 respectively. Inside the helmet-mounted display 10, display panels 112L and 112R, lenses 113L and 113R, and infrared sensors 114L and 114R are disposed. When the user wears the helmet-mounted display 10, the left eye EYE_{L} will see the image displayed on the display panel 112L through the lens 113L, and the right eye EYE_{R} will see the image displayed on the display panel 112R through the lens 113R. The infrared sensor 114L is disposed on the periphery of the lens 113L and emits infrared light toward the left eye EYE_{L}. The infrared sensor 114L determines the position of the pupil of the left eye EYE_{L} by using the difference of the reflected intensities between the pupil and the iris and the sclera. Specifically, at least the distance MPDL of the pupil of the left eye EYE_{L} relative to the nasal bridge centerline NC can be obtained. Similarly, the infrared sensor 114R is disposed on the periphery of the lens 113R and emits infrared light toward the right eye EYE_{R}. The infrared sensor 114R determines the position of the pupil of the right eye EYE_{R} by using the difference of the reflected intensities between the pupil and the iris and the sclera. Specifically, at least the distance MPDR of the pupil of the right eye EYE_{R} relative to the nasal bridge centerline NC can be obtained. In addition, the pupil distance PD (=MPDL+MPDR) of both eyes can also be obtained by the infrared sensors 114L and 114R.

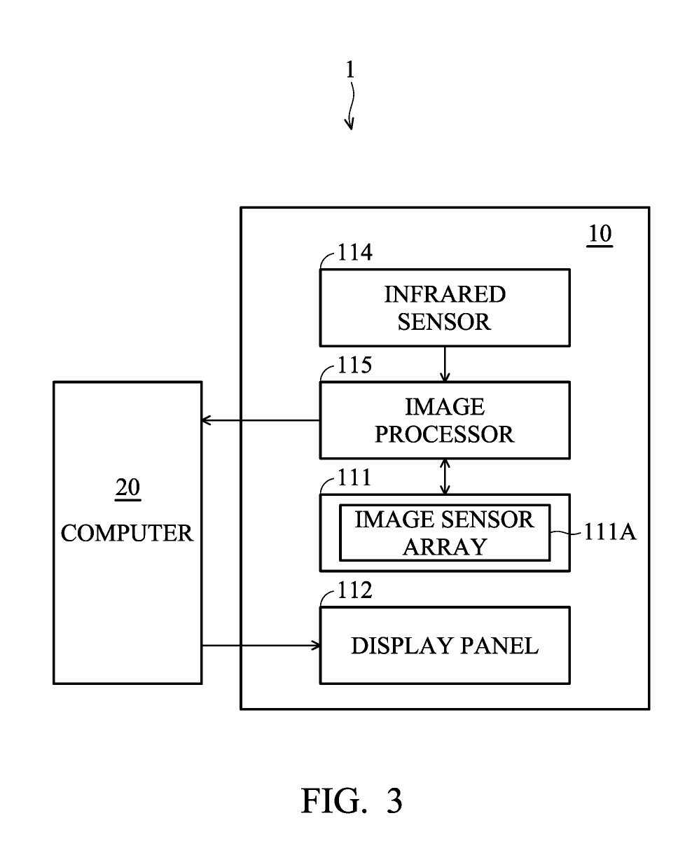

With the aforementioned infrared sensors 114L and 114R, the present invention can capture the user's pupil position or distance, and then perform further visual field calibration. The following is a description of the basic architecture of mixed reality display system for displaying mixed images. FIG. 3 is an architecture diagram showing a mixed reality display system in according to an embodiment of the present invention. In the mixed reality display system 1 of FIG. 3, the foregoing helmet-mounted display 10 and a computer 20 connected to the helmet-mounted display 10 by wire or wirelessly are included. In the helmet-mounted display 10, the infrared sensor 114 senses the intensity of the infrared light reflected from the human eye and outputs an intensity signal to an image processor 115. The image processor 115 obtains the pupil position (or distance) of the human eye according to the intensity signal and uses the information of the pupil position to obtain the visual field corresponding to the human eye. The image processor 115 crops a visual field image corresponding to the visual field from the environment image sensed in an image sensor array 111A of the camera 111 (details will be described later), and then transmits the visual field image through, for example, a USB 3.0 or the like Wired transmission method, or other wireless transmission method to the computer 20. The computer 20 calculates a desired virtual image (including the virtual object, the environmental effect or the information) according to the visual field image, and superimposes the virtual image on the visual field image to form a mixed image. The computer 20 transmits the mixed image to the helmet-mounted display 10 via a wired transmission method such as HDMI or other wireless transmission method and displays the mixed image on the display panel 112. In this way, the mixed reality display system 1 allows the user to experience a mixed environment in which the real environment image and the virtual image are combined.

A visual field calibration method of a head-mounted display of the present invention will be described below. A horizontal angle of view of a common human eye (monocular) is 167 degrees, and the vertical angle of view is 120 degrees. However, the angle of view of the camera 111 of the helmet-mounted display 10 in the horizontal and vertical directions is greater than the angle of view of the human eye. Therefore, the environment image captured by the camera 111 is substantially greater than the visual field of the human eye. In this way, if only a visual field image corresponding to the visual field of the human eye is cropped from the environment image and output, the bandwidth of the signal can be transmitted, and the computational load can be reduced. On the other hand, it is also possible to provide an image corresponding to the visual field viewed by the human eye so as to prevent the user from having symptoms such as blurred vision, dizziness and the like.

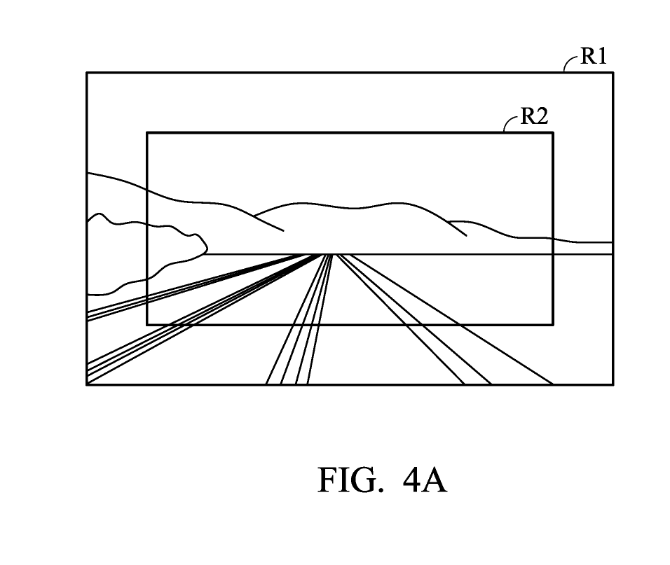

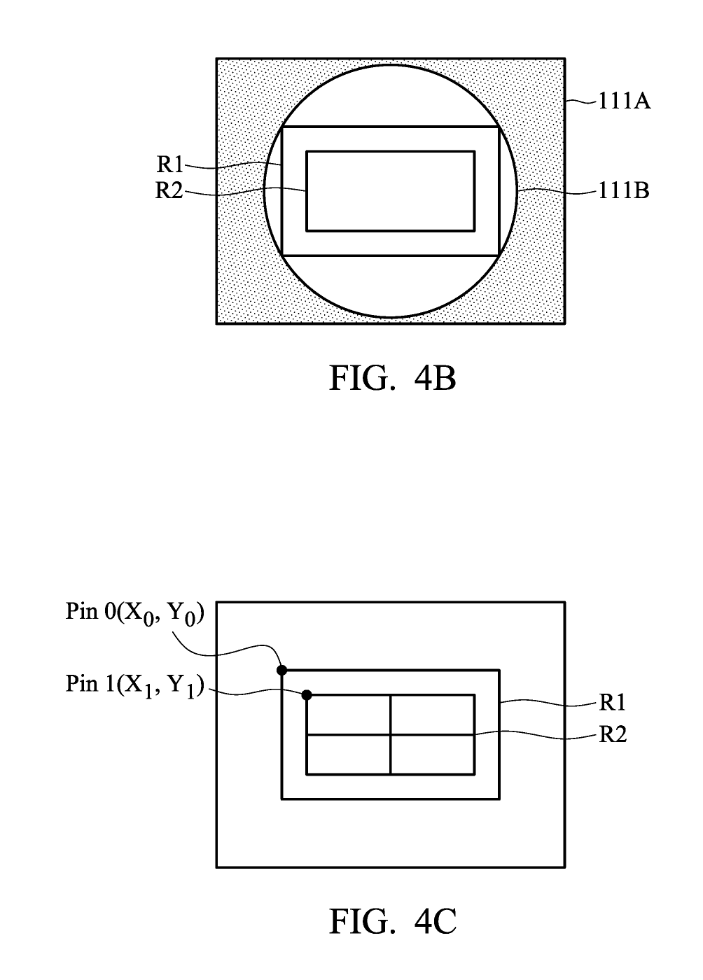

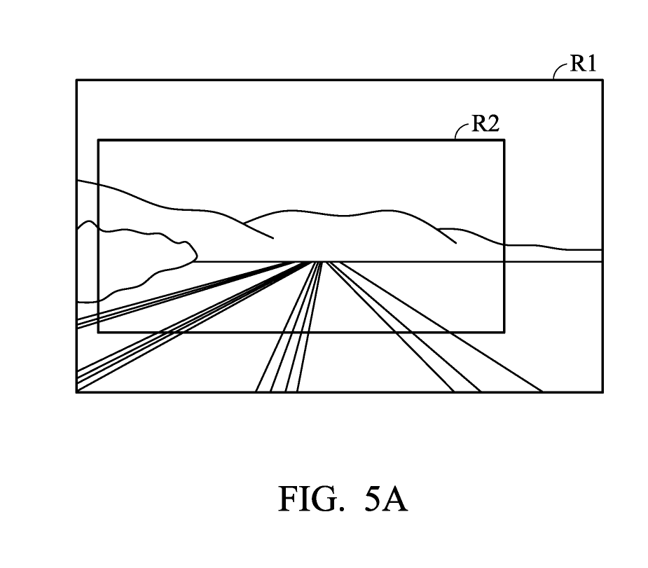

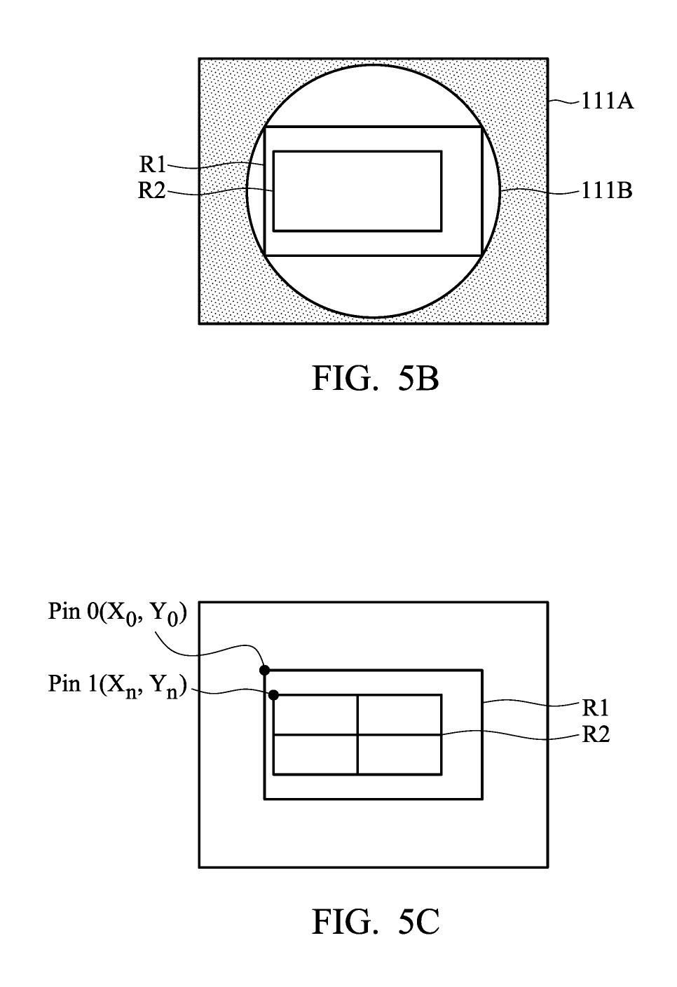

FIGS. 4A-4C are diagrams for explaining the positions of an environment image and a visual field image with respect to an image sensor array when the pupil distance of human eyes PD is 63 mm. FIGS. 5A-5C are diagrams for explaining the positions of an environment image and a visual field image with respect to an image sensor array when the pupil distance of human eyes PD is 66 mm. Since the pupil distance PD of the human eye generally falls in the range of 60 to 66 mm when viewed in parallel with the line of sight, the helmet-mounted display 10 in the embodiment of the present invention sets the lens 111B of the camera 111 with a preset pupil distance PD of 63 mm. When a user with a pupil distance PD of 63 mm wears the helmet-mounted display 10, the user's visual field falls in the center of the range of environment images that the camera 111 can capture.

Specifically, the horizontal angle of view of the lens 111B of the camera 111 is 200 degrees, which is greater than 167 degrees of horizontal viewing angle of the human eye. Therefore, when the user with the pupil distance PD of 63 mm wears the helmet-mounted display 10, as shown in FIG. 4A, the range of the environment image that can be captured by the lens 111B is R1, but the visual field actually visible to the human eye is R2. Referring to FIG. 4B, the image sensor array 111A is a square array of 6.29 mm and 4.71 mm in length and width. The image sensor array 111A has 3000 pixels in a horizontal direction (a length direction) and in a vertical direction (a width direction) respectively. The range of the image sensor array 111A can cover the maximum range (200 degrees in the horizontal direction and 200 degrees in the vertical direction) captured by the lens 111A with a diameter of 4.55 mm. In this case, the visual field R2 of the human eye is located at the center of the image sensor array 111A. As shown in FIG. 4C, since the image in the visual field R1 of the human eye only needs to be sensed by the pixels in a rectangular area in the image sensor array 111A, the image sensor array 111A can use a pixel of the array coordinate (X₁, Y₁) as a starting pixel Pin 1 which is located in, for example, the upper left corner of the rectangular area, and then sequentially output the image sensing signals sensed by all the pixels in the rectangular area from the starting pixel Pin 1.

When the user with the pupil distance PD of 66 mm wears the helmet-mounted display 10, as shown in FIG. 5A, the range of the environment image captured by the lens 111B is still R1, but the visual field R2 of the human eye is changed due to the change of the pupil distance. There is a horizontal offset. In this case, as shown in FIG. 5B, the visual field R2 of the human eye is horizontally deviated from the center of the image sensor array 111A. In this way, the rectangular area of the image sensor array 111A that needs to output the image sensing signal is changed, and the image processor 115 uses the information of the pupil distance (calculated from the intensity of the reflected light from the pupil detected by the infrared sensor 114) to calculate and set a rectangular area in the image sensor array 111A that needs to output the image sensing signal. As shown in FIG. 5C, after being calculated, the image processor 115 sets the image sensor array 111A to use a pixel of the array coordinate (Xn, Yn) as the starting pixel Pin 1 which is located in, for example, the upper left corner of the rectangular area, and then sequentially output the image sensing signals sensed by all the pixels in the rectangular area from the starting pixel Pin 1.

By extracting a pixel area corresponding to the visual field of the human eye from the image sensor array 111A and outputting only the result of the image sensing signal in the pixel area, the output data bandwidth can be reduced. On the other hand, it is also possible to adjust the visual field image suitable for the user depending on the pupil distance of the user.

As described above, the image processor 115 sets a rectangular pixel area output by the image sensor array 111A according to the visual field R2 of the human eye. However, the present invention may also adopt another processing method. For example, the image sensor array 111A only outputs the image sensing signal in a rectangular area corresponding to the range R1 of the environment image. When the image sensing signal is output to the buffer memory of the image sensor 115, the image sensor 115 cut the desired image range according to the visual field R2 of the human eye.

Specifically, when a user with a pupil distance PD of 63 mm puts on the helmet-mounted display 10 and the visual field R2 of the human eye is located at the center of the range R1 of the environment image as shown in FIGS. 4A-4C, the image sensor array 111A outputs the image sensing signals corresponding to the pixels in the range R1 of the environment image. That is to say, the pixel of the array coordinate (X₀, Y₀) is used as the starting pixel Pin 0 located in the upper left corner of the rectangular area. Then, from the starting pixel Pin 0, the image sensing signals sensed by all the pixels in the rectangular area corresponding to the range R1 of the environment image are sequentially output. When all the image sensing signals in the area are output to the image sensor 115, the image sensor 115 crops the image sensing signals corresponding to the visual field R2. When a user with a pupil distance PD of 66 mm puts on the helmet-mounted display 10 and the visual field R2 of the human eye is to the left of the range R1 of the environment image as shown in FIGS. 5A-5C, the image sensor array 111A still uses the pixel of the array coordinate (X₀, Y₀) as the starting pixel Pin 0 and outputs the image sensing signals sensed by all the pixels in the rectangular area corresponding to the range R1 of the environment image. Then the image sensor 115 crops the image sensing signals corresponding to the visual field R2.

It should be noted that the above description shows that the helmet-mounted display 10 of the present invention can be initially set according to the pupil distance of different users to provide a suitable visual field image. In practice, however, even the same user may change the pupil distance when looking at the far side and looking at the near side. For example, the pupil distance of the user looking at the near side is usually 2 to 4 mm less than the pupil distance of the same user looking at the far side. Therefore, even if the user who wears the helmet-mounted display 10 is the same person, the visual field changes as the user looks the far side and the near side. In addition to the visual field calibration just performed when the helmet-mounted display 10 is worn, the present invention can track the user's pupil position or distance uninterruptedly, and instantly provide the user with a visual field corresponding to the user looking at the near side or the far side.

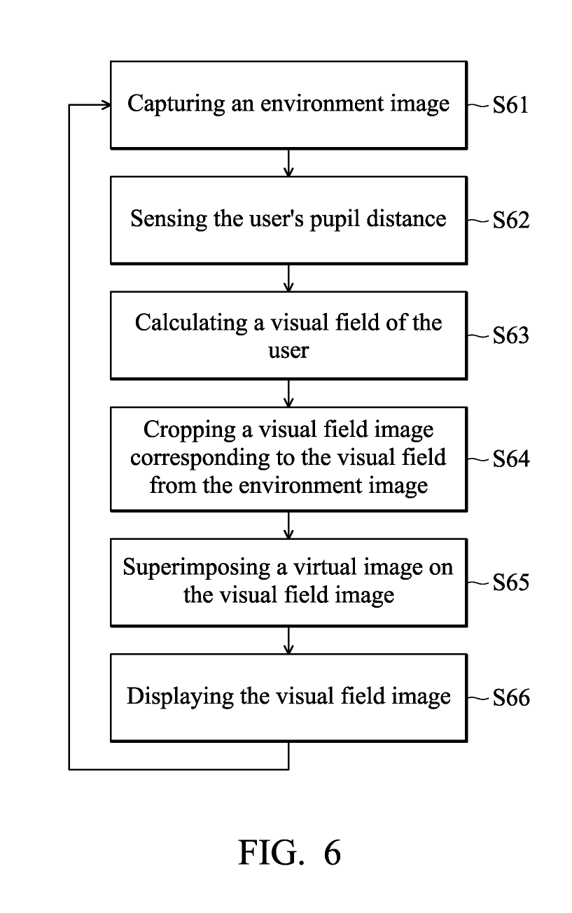

FIG. 6 is a flowchart showing a visual field calibration method of a helmet-mounted display in according to an embodiment of the present invention. When the user wears the helmet-mounted display 10 of the embodiment of the present invention, the helmet-mounted display 10 starts to perform visual field calibration. First, the camera 111 continuously shoots the environment image (step S61). The infrared sensor 114 then senses the intensity of the reflected light, thereby allowing the image processor 115 to calculate the user's pupil distance or position relative to the nasal bridge centerline NC (step S62). Then, the image processor 115 calculates the visual field of the user by using the information of the pupil distance or position of the user (step S63). The image processor 115 obtains the image sensing signals of the pixels in the area of the image sensor array 111A corresponding to the visual field, and crops a visual field image corresponding to the visual field from the environment images captured by the image sensor array 111A (step S64). The image processor 115 outputs the visual field image to the external computer 20, and the computer 20 superimposes the virtual image (including the virtual object, the environmental effect or the information) on the visual field image according to the visual field image (step S65). The computer 20 transmits the visual field image on which the virtual image is superimposed to the display panel 112 of the helmet-mounted display 10. The display panel 112 displays the visual field image on which the virtual image is superimposed (step S66), allowing the user to experience the effect of mixed reality. After the step S66 is executed, the process returns to the step S61 to continuously track the dynamics of the eyeball to provide a suitable visual field image.

According to the helmet-mounted display, the visual field calibration method thereof, and the mixed reality display system, with software calibration, images suitable for the visual field of the user can be displayed according to the user's pupil distance. Furthermore, visual field images can be adjusted instantly while the user watches near objects or far objects.

The above-disclosed features can be combined, modified, substituted, or diverted to one or more of the disclosed embodiments in any suitable manner without being limited to a specific embodiment.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A helmet-mounted display, comprising
a camera capturing an environment image outside the helmet-mounted display;
an infrared sensor sensing the pupil position of a human eye;
an image processor calculating the visual field of the human eye according to the pupil position and cropping a visual field image corresponding to the visual field from the environment image; and
a display panel displaying the visual field image.

2. The helmet-mounted display as claimed in claim 1, wherein the camera comprises an image sensor array formed from a plurality of pixels, and
the image processor extracts only image sensing signals of the pixels in an area corresponding to the visual field in the image sensor array.

3. The helmet-mounted display as claimed in claim 2, wherein the image processor sets coordinates of pixels of the image sensor array that need to output the image sensing signal according to the visual field.

4. The helmet-mounted display as claimed in claim 1, wherein the pupil position is the distance between the pupil and a nasal bridge centerline.

5. A mixed reality display system, comprising:
a camera capturing an environment image;
an infrared sensor sensing the pupil position of a human eye;
an image processor calculating the visual field of the human eye according to the pupil position and cropping a visual field image corresponding to the visual field from the environment image;
a computer receiving the visual field image and superimposing a virtual image to form a mixed image; and
a display panel displaying the mixed field image.

6. The mixed reality display system as claimed in claim 5, wherein the camera, the infrared sensor, the image processor, and the display panel form a helmet-mounted display.

7. The mixed reality display system as claimed in claim 5, wherein the camera comprises an image sensor array formed from a plurality of pixels, and
the image processor extracts only image sensing signals of the pixels in an area corresponding to the visual field in the image sensor array.

8. The mixed reality display system as claimed in claim 7, wherein the image processor sets coordinates of pixels of the image sensor array that need to output the image sensing signal according to the visual field.

9. A visual field calibration method of a helmet-mounted display, comprising:
capturing an environment image that shows the exterior of the helmet-mounted display;
sensing a pupil position of a user of the helmet-mounted display;
calculating the user's visual field according to the pupil position;
cropping a visual field image corresponding to the user's visual field from the environment image; and
displaying the visual field image.

10. The visual field calibration method as claimed in claim 9, further comprising:
superimposing a virtual image on the visual field image.
